(19) United States
(12) Patent Application Publication
(10) Pub. No.: US 2016/0003496 A1
(43) Pub. Date: Jan. 7, 2016

(54) MODULAR SOLAR FIELD

(71) Applicant: BRENMILLER ENERGY LTD., Tel Aviv (IL)

(72) Inventors: Avraham Brenmiller, Ramat Hasharon (IL); Eli Lipman, Rishon Lezion (IL); Dan Raz, Haifa (IL); Gregory Rinberg, Haifa (IL); Zeev Geva, Haifa (IL)

(73) Assignee: BRENMILLER ENERGY LTD., Tel Aviv (IL)

(21) Appl. No.: 14/766,752

(22) PCT Filed: Mar. 3, 2014
(86) PCT No.: PCT/IB2014/059559

§ 371 Date: Aug. 9, 2015

(30) Foreign Application Priority Data
Mar. 24, 2013 (IL) 225456

(51) Int. Cl. F24J 2/12; F24J 2/38; F24J 2/05; F24J 2/24

(52) U.S. Cl. CPC F24J 2/12; F24J 2/24; F24J 2/38; F24J 2/055; F24J 2002/0046

(57) ABSTRACT

A solar thermal energy system (20) includes a plurality of modules (22), which are connected end-to-end to define an extended solar trough. Each module includes a frame, having an outer edge of circular profile and an inner edge of parabolic profile, having a focus at a geometrical center of the circular profile. The frame includes first and second end segments (42) at respective first and second ends of the module, and a pair of rigid torque tubes (44) connected longitudinally between the first and second end segments. A motorized drive (46) engages and rotates the outer edge of the frame about the geometrical center. Multiple mirror segments (40) are fitted to the inner edge of the frame. At least one heat transfer tube segment (24) is held stationary at the geometrical center of the frame.

### FIELD OF THE INVENTION

The present invention relates generally to solar energy, and particularly to systems and methods for solar generation of concentrated thermal energy.

### BACKGROUND

In solar thermal energy systems, the rays of the sun are concentrated to heat a fluid to high temperature (generally in the range of 300-550° C.). Typically, the heated fluid is piped from the solar concentrator to drive a turbine in order to generate electricity. Various types of concentrator geometries are known in the art, most notably parabolic troughs, comprising long parabolic reflectors with a pipe containing the heat-transfer fluid running along the focal line of the reflectors. The troughs typically rotate in the course of the day to track the motion of the sun. Large-scale assemblies of multiple, parallel solar troughs of this sort are sometimes referred to as “solar fields.”

A system of solar troughs is described, for example, in U.S. Patent Application Publication 2009/0183731. The solar collectors in this system comprise parabolic reflectors, which rotate around a fixed thermal receiver tube using synchronously running motors, which run, even if some of them fail, without having to stop entire collector system. The convex parts of the parabolic reflectors are supported with lightweight and resistant filling materials, which are said to decrease the bending and the torsion effects generated by the wind and to decrease the load imposed on the motors. Multi-piece parabolic mirrors are used instead of single-piece mirrors in order to prevent the system from suffering too much efficiency loss even if some reflector parts are broken.

As another example, U.S. Patent Application Publication 2011/0168161 describes a solar trough field system comprising multiple parabolic reflectors and a thermal receiver tube centered at the focus of the parabolic reflectors. The thermal receiver tube consists of a metal heat receiving pipe and a glass tube, which are nested so that the glass tube surrounds the metal heat receiving pipe from outside. A vacuum seal and glass tube connector system connects the glass tubes and the thermal heat receiving pipe to each other. A rotating support unit connects the parabolic panel to the glass tube connector system and permits the thermal receiver tube to stay stationary while the parabolic panel is rotating around it. A flexible expansion unit located at the end of each parabolic trough unit provides a vacuum seal while the heat receiving pipe moves due to heat expansion.

### SUMMARY

Embodiments of the present invention that are described hereinbelow provide apparatus and methods that can be used in assembling solar thermal energy systems with enhanced performance and reduced cost.

There is therefore provided, in accordance with an embodiment of the present invention, a solar thermal energy system, including a plurality of modules, which have a predefined module length and are configured to be connected end-to-end to define an extended solar trough having a system length that is an integer multiple of the module length. Each module includes a frame, having an outer edge of circular profile and an inner edge of parabolic profile, having a focus at a geometrical center of the circular profile. A motorized drive is configured to engage and rotate the outer edge of the frame about the geometrical center. Multiple mirror segments are fitted to the inner edge of the frame. At least one heat transfer tube segment is held stationary at the geometrical center of the frame while the frame rotates and is configured to be connected to the heat transfer tube segment of an adjoining module, whereby a heat transfer fluid flows between the connected segments.

In some embodiments, the frame includes first and second end segments at respective first and second ends of the module, wherein the end segments include the outer edge that is engaged by the motorized drive. Multiple mirror supports define the inner edge of parabolic profile. A truss structure below the parabolic profile connects the mirror supports to the end segments. The second end segment may serve as the first end segment of the adjoining module.

In a disclosed embodiment, the frame includes a pair of rigid torque tubes connected longitudinally between the first and second end segments. Typically, the mirror supports have respective first and second ends, and each end is connected to one of the pair of torque tubes.

In some embodiments, the motorized drive includes a respective motor that is coupled to rotate each end segment. In a disclosed embodiment, the motorized drive includes a chain, which is attached to and extends around the outer edge of the end segment. A drive wheel is coupled to engage the chain and is driven to rotate by the respective motor so as to advance along the chain, thereby rotating the frame. The system may include a pair of sensors, which are configured to sense advancement of the chain and to provide, responsively to the advancement, signals indicative of an angle of inclination of the frame.

Typically, the end segments, mirror supports, and truss structure are pre-galvanized and are connected to one another on site without welding.

In a disclosed embodiment, the system includes multiple bases, which are mounted on foundation posts and are configured to support the plurality of the modules, each of the bases including a positioning assembly, which is operable to align the bases with one another along the extended solar trough, thereby aligning the modules supported by the bases.

In a disclosed embodiment, the at least one heat transfer tube segment includes an inner tube, for containing the heat transfer fluid, and an outer tube, surrounding the inner tube and defining an insulating space between the inner and outer tubes. One or more joints connect the inner tube of the at least one heat transfer tube segment to the inner tube of an adjoining heat transfer tube segment, while terminating the outer tubes so that the insulating space of the heat transfer tube segment is separate from the insulating space of the adjoining heat transfer tube segment.

In a disclosed embodiment, a center of mass of the frame is not located at the geometrical center of the circular profile.

There is also provided, in accordance with an embodiment of the present invention, apparatus for capture of solar energy, including a solar trough, which includes a mirror having a parabolic profile, which is configured to focus solar energy toward a focus of the parabolic profile. A motorized drive is coupled to rotate the mirror about the focus. A heat transfer tube includes multiple tube segments, which are connected at joints therebetween so that a heat transfer fluid can flow between the connected segments. A plurality of tube supports each include a base, which is fixed to the solar trough, and a ring, which is configured to hold one of the joints of the heat transfer tube at the focus of the parabolic profile, and which contains bearings configured to roll against the one of the joints so that the heat transfer tube remains stationary while the frame rotates about the center.

Typically, the heat transfer tube has a first outer diameter, and the joints have a second outer diameter, which is smaller than the first diameter, and the bearings of the ring define an inner diameter that engages the second outer diameter.

There is additionally provided, in accordance with an embodiment of the present invention, a solar reflector, including a frame, having an inner edge of parabolic profile, which defines a focal line. Multiple mirror segments, including tempered plate glass, are fitted side-by-side to the inner edge of the frame while bending to conform to the parabolic profile.

In a disclosed embodiment, the reflector includes multiple clips, which are configured to grip a margin of the tempered plate glass and to be attached to the frame in proximity to the inner edge so as to secure the mirror segments to the frame. Typically, the clips are configured to clip into corresponding receptacles distributed along the inner edge of the frame.

There is further provided, in accordance with an embodiment of the present invention, a method for assembling a solar thermal energy system, which includes providing a plurality of modules, which have a predefined module length, each module including a frame, which has an outer edge of circular profile and an inner edge of parabolic profile, having a focus at a center of the circular profile. One or more heat transfer tube segments are mounted in a stationary position at the center of the frame of each module. Multiple mirror segments are fitted to the inner edge of the frame of each module. The plurality of the modules are connected together, end-to-end, so as to define an extended solar trough having a system length that is an integer multiple of the module length. A respective motorized drive is applied to each module so as to engage and rotate the outer edge of the frame about the center. The heat transfer tube segments of the connected modules are joined together, whereby a heat transfer fluid flows between the joined tube segments.

The method may include mounting multiple bases on foundation posts, each of the bases including a positioning assembly, and adjusting the positioning assembly so as to align the bases with one another along the extended solar trough, wherein providing the plurality of the modules includes mounting the frame of each module on a respective base.

Additionally or alternatively, providing the plurality of the modules includes, in each module, assembling a pair of torque tubes between a pair of end segments, and connecting mirror supports between the torque tubes, thereby defining the frame to support the multiple mirror segments. Assembling the torque tubes and connecting the mirror supports may include fitting clamps to the torque tubes for connection of the mirror supports and assembling the mirror supports in a jig at a site of the thermal solar energy system without welding. Typically, the end segments, mirror supports, and torque tubes are pre-galvanized and are connected to one another on site without welding.

The present invention will be more fully understood from the following detailed description of the embodiments thereof, taken together with the drawings in which:

### BRIEF DESCRIPTION OF THE DRAWINGS

FIG. 1 is a schematic pictorial illustration of a solar thermal energy system, in accordance with an embodiment of the present invention;

FIG. 2 is a schematic pictorial illustration showing segments of two parallel solar troughs, in accordance with an embodiment of the present invention;

FIG. 3 is a schematic pictorial illustration showing details of a solar trough module, in accordance with an embodiment of the present invention;

FIG. 4 is a schematic pictorial illustration showing details of a motion assembly for a solar trough, in accordance with an embodiment of the present invention;

FIG. 5A is a schematic pictorial illustration showing assembly of segments of a heat transfer tube in a rotary support, in accordance with an embodiment of the present invention;

FIG. 5B is a schematic pictorial illustration showing the elements of FIG. 5A after assembly;

FIG. 6A is a schematic pictorial illustration showing assembly of a mirror segment onto a support, in accordance with an embodiment of the present invention;

FIG. 6B is a schematic pictorial illustration showing the elements of FIG. 6A after assembly;

FIG. 7 is a schematic pictorial illustration showing assembly of the base of a solar trough module, in accordance with an embodiment of the present invention;

FIG. 8 is a schematic pictorial illustration showing assembly of clamps on a torque tube, in accordance with an embodiment of the present invention; and

FIG. 9 is a schematic pictorial illustration showing assembly of a mirror support, in accordance with an embodiment of the present invention.

### DETAILED DESCRIPTION OF EMBODIMENTS

### Overview

Solar thermal energy plants for electrical power generation are generally large-scale operations, which are costly and complex to install and maintain. Embodiments of the present invention that are described herein provide components and methods for use in a simplified, modular approach to solar field assembly. These components and methods can be applied economically in energy generation facilities over a wide range of scales and power output levels. They facilitate reliable operation and low cost of installation and maintenance.

In the disclosed embodiments, a solar thermal energy system is made up of multiple modules, which are connected end-to-end to define an extended solar trough. The system length of the trough is an integer multiple of the module length. Multiple troughs of this sort, possibly of varying lengths (depending on the number of modules in each trough), can be arranged in parallel to fit the solar field to the available space and topography.

Each module comprises a frame, with an outer edge having a circular profile and an inner edge of parabolic profile. The focus of the parabolic profile is along the line corresponding to the center of the circular profile, i.e., along the central axis of a cylinder whose circumference is defined by the outer, circular profiles. To track the sun's motion, each module has a motorized drive, which engages and rotates the outer edge of the frame about the center. Thus, the trough is driven my multiple motors, which are distributed along the length of the trough, typically at intervals equal to the module length, and operate in mutual synchronization. This sort of distributed drive enables the use of low-cost, relatively low-power motors and enhances the robustness of the system against motor failure.

In some embodiments, each module comprises multiple mirror segments, which are fitted side-by-side to the inner edge of the frame. The inventors have found that tempered plate glass may be used advantageously in making the mirror segments. Tempered glass sheets, typically several millimeters thick, are flexible enough to bend into the parabolic shape of the inner, parabolic profile of the frame, but at the same time strong enough to resist breakage during installation and operation of the system. Novel clips, as described below, may be attached to the inner edge of the frame while gripping the margin of the tempered plate glass in order to secure the mirror segments to the frame.

In the disclosed embodiments, a heat transfer tube is held stationary along the center line of the frame, while the frame rotates the mirror segments around the tube. A heat transfer fluid flows through the tube and absorbs heat from the sun that is concentrated by the mirror segments. The heat transfer tube comprises multiple tube segments, which are connected end-to-end within and between the adjoining modules. Each of these tube segments comprises an inner tube, in which the heat transfer fluid is contained, and an outer tube, which surrounds the inner tube and thus defines an insulating space (which is typically evacuated) between the inner and outer tubes.

At the joints between adjoining tube segments, the inner tubes of the tube segments are connected to one another, while the outer tubes are terminated. Consequently, the insulating space of each segment is separate from the adjoining segments, and the joints typically have a smaller outer diameter than that of the outer tube. The tube segments are held in place by tube supports, which are attached at their bases to the frame and have a ring with an inner diameter that is chosen to fit around and engage the joints. Bearings inside the ring roll against the joint and thus permit the tube segments to remain stationary, without rotation or transverse movement, while the frame rotates around them.

In the embodiment described below, the above features are shown, for the sake of clarity, as component elements of the same system. In alternative embodiments, however, each of these features may be applied advantageously independently of the others.

### System Description

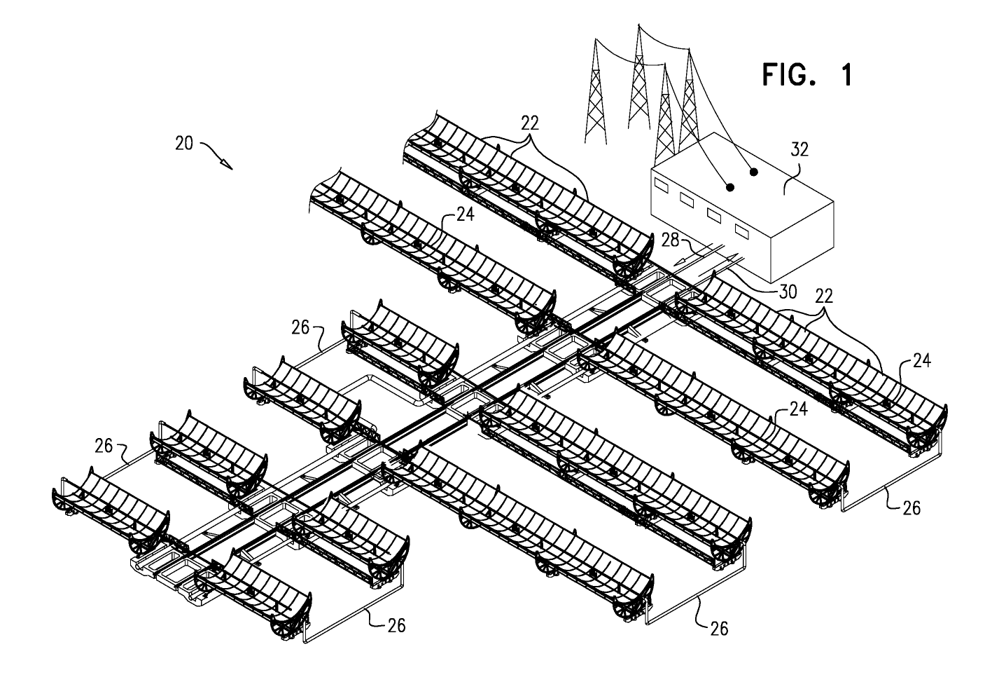

FIG. 1 is a schematic pictorial illustration of a solar thermal energy system 20, in accordance with an embodiment of the present invention. This sort of system is also referred to as a “solar field.” Multiple modules 22 are connected end-to-end to define a parabolic solar trough, and multiple troughs of this sort are typically arranged in parallel along lines running north-south. Heat transfer tubes 24 run along the central axes of the solar troughs, with interconnecting segments 26 to create closed flow loops. Tubes 24 and segments 26 remain stationary in operation of system 20, while modules 22 rotate about the tubes to track the sun, as described further hereinbelow.

A heat transfer fluid flows through tubes 24 and absorbs solar energy that is concentrated by the solar troughs. Any suitable type of fluid may be used for this purpose, including both liquid and gaseous materials. Example fluids include high-temperature oils, water, and carbon dioxide. An inlet pipe 28 conveys cool fluid to tubes 24, while an outlet pipe 30 collects the heated fluid and conveys it to a power extraction block 32. Typically, block 32 contains an electric generator, such as a turbine, which is driven by the heated fluid. Block 32 may also contain means for storing excess heat, for later conversion to electricity. After extraction of the heat in block 32, the fluid flows back to tubes 24 via inlet pipe 28.

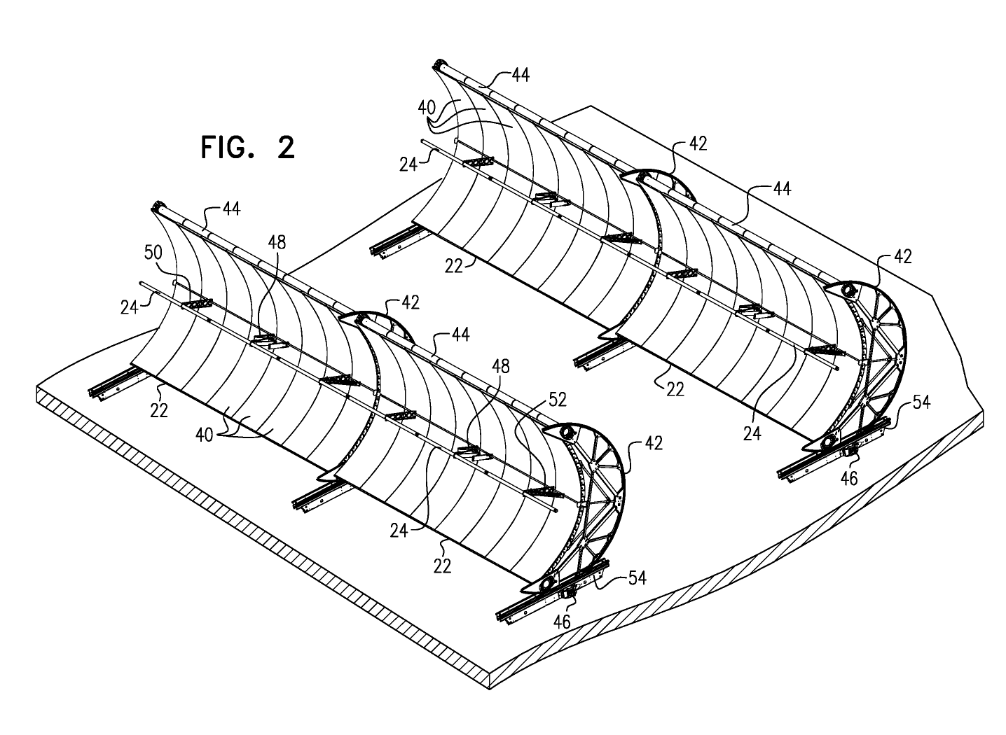

FIG. 2 is a schematic pictorial illustration showing segments of two parallel solar troughs in system 20, in accordance with an embodiment of the present invention. The troughs are shown in their early morning configuration, facing east, and rotate from east to west about their central axes, i.e., about tubes 24, in the course of the day.

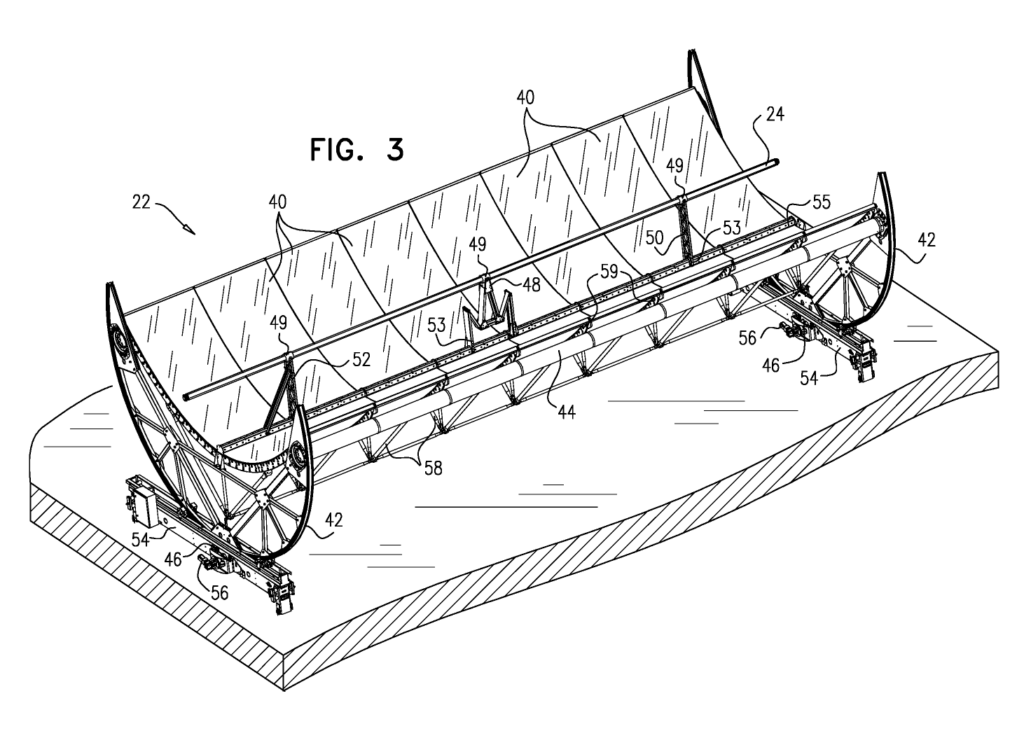

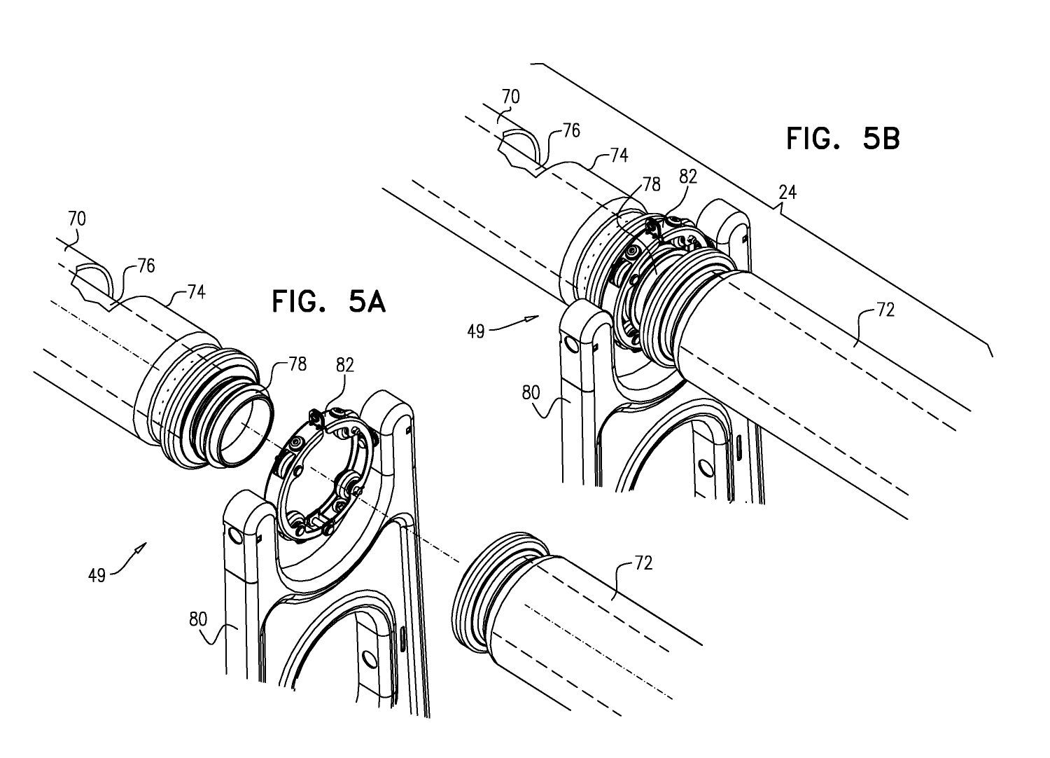

Two modules 22 within each trough are shown in this figure. Each module comprises multiple mirror segments 40, which are typically made from tempered plate glass with a suitable reflective coating. The mirror segments are held in a frame, of which end segments 42 and torque tubes 44 are seen in FIG. 2. End segments 42 may be shared between adjoining modules 22, as illustrated by the central end segments in the figure. The end segments have a circular outer edge and a parabolic inner edge, to which mirror segments 40 are fitted. The outer edge defines a cylinder, which is centered along an axis where heat transfer tubes 24 are mounted. The same axis is also the focus of the parabolic inner edge of the frame. Tubes 24 are held stationary in this central, focal position by tube supports 48, 50, 52, which are further described hereinbelow with reference to FIGS. 3 and 5A/B.

A pair of torque tubes 44 (of which only one can be seen in FIG. 2) is connected longitudinally between end segments 42 of each module 22, at opposing corners of the end segments. The torque tubes are made from rigid material in order to add resistance against bending of the frame, due to strong winds, for example, that could otherwise damage mirror segments 40.

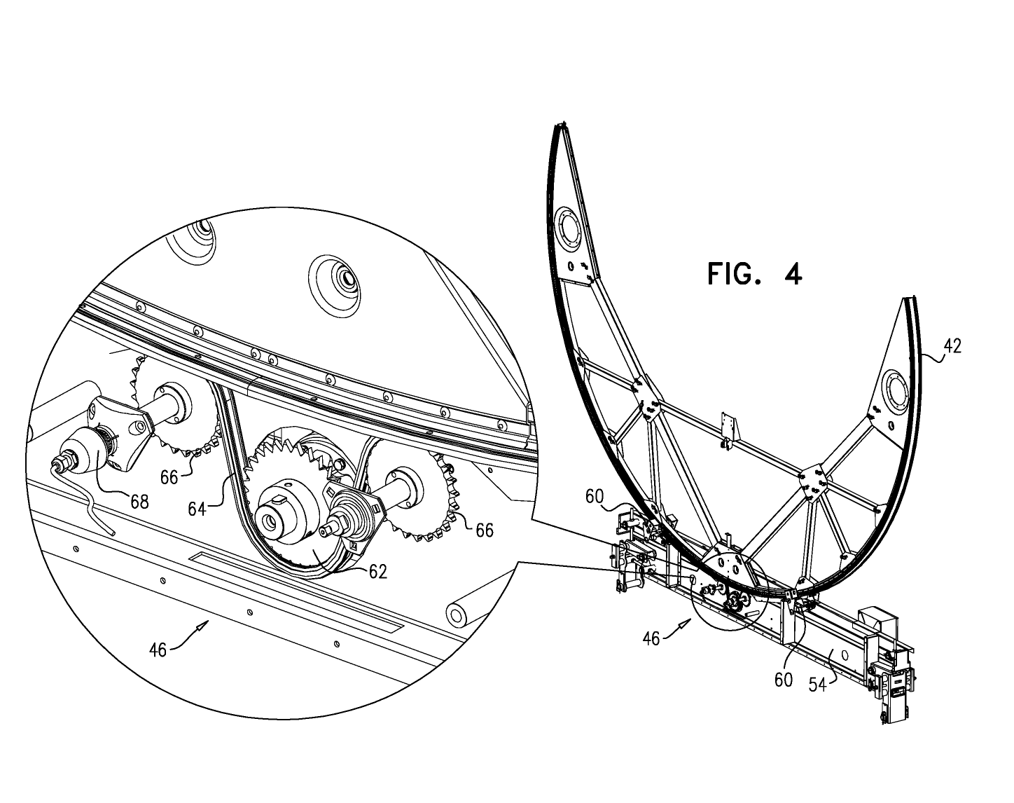

The outer edges of end segments 42 rest on corresponding bases 54, each containing a motorized drive 46, which engages and drives the outer edge, as described hereinbelow with reference to FIG. 4. In an alternative embodiment (not shown in the figures), heat transfer tubes 24 or another suitable heat collection element may be hung from a suitable superstructure, by cables, for example, at the focus of the parabolic mirror segments. This alternative embodiment is advantageous in that it requires no contact at all between the moving trough modules and the stationary heat collection element.

Modules 22 have a predefined length, which is small enough to allow for convenient transport, assembly, and propulsion by drives 46, but still large enough to provide certain economies of size and scale. For example, the length of each module, measured between end segments 42, may be 12 m, while the diameter is about 5-6 m. These modules may thus be assembled into solar troughs of any desired length that is a multiple of 12 m. In a typical installation, eight to ten such modules are assembled end-to-end to create a solar trough on the order of 100 m long, but shorter or longer assemblies are likewise possible.

### Module Structure and Assembly

FIG. 3 is a schematic pictorial illustration showing further details of module 22, in accordance with an embodiment of the present invention. In addition to end segments 42 and torque tubes 44, the frame holding mirror segments 40 comprises multiple mirror supports 59, which have an inner edge of parabolic profile like the end segments. A structure of trusses 58 below the parabolic profile connects mirror supports 59 to end segments 42. This structure, together with torque tubes 44, provides strength and rigidity with low mass, thus reducing the amount of force that must be exerted by drives 46 in rotating the frame.

The low-mass design of module 22 is important particularly since the center of rotation (at heat transfer tube 24) is not the center of mass of the module, in contrast to most designs that are known in the art. A relatively small electrical motor 56, such as a stepper motor, is therefore sufficient to provide the desired rotation, particularly since the work is divided among multiple motors 56 and drives 46.

Tube supports 48, 50, 52 have respective bases 53, which are fixed to a support member 55 within the frame of module 22. A ring 49 at the opposite end of each tube support holds heat transfer tube 24 in place at the focus of the parabolic profile of mirror segments 40. As shown in FIG. 5, ring 49 is typically fitted over a joint in tube 24 and contains bearings that roll against the joint so that the heat transfer tube remains stationary while the frame rotates about it. Alternatively, other sorts of rotating ring arrangements may be used. Supports 48, 50, 52 may be of different types, as shown in the figure, in order to accommodate expansion and contraction of tube 24 and other parts of module 22, while keeping the tube centered at the focus of the parabolic profile of the mirror segments.

FIG. 4 is a schematic pictorial illustration showing details of one of end segments 42, base 54 and motion assembly 46, in accordance with an embodiment of the present invention. End segment 42 rests on bearings 60, which are fixed to base 54. The bearings are designed both to support the end segment and to prevent crash or disconnection in the event of strong gusts of wind. A drive chain 64 extends around the outer edge of end segment 42, and the ends of the chain are attached to the upper corners of the end segment. A drive wheel 62 engages chain 64 and is driven by motor 56 (not shown in this figure) to rotate, so as to advance along the chain, thereby rotating the frame.

Cogs 66 assist in guiding the chain and may optionally be coupled to a sensor 68, such as an encoder, for tracking and controlling the rotation of end segment 42. For added accuracy, two such sensors may be used, one on each cog, to account for variations in chain tension and position. The sensor readings may be calibrated initially against the actual, physical angle of inclination of module 22 (by measuring the angle with an inclinometer, for example). The calibration data may then be stored in a table and used in accurately coordinating the motion of all the modules making up a given trough.

Reference is now made to FIGS. 5A and 5B, which are schematic pictorial illustrations showing assembly of segments 70, 72 of heat transfer tube 24 in ring 49, in accordance with an embodiment of the present invention. FIG. 5A shows segments 70, 72 before assembly, while FIG. 5B shows the elements of FIG. 5A after assembly.

Tube 24 comprises multiple segments 70, 72, . . . , which are arranged and joined end-to-end at joints 78. Some of these joints (such as the joint shown in FIG. 5A/B) join tube segments within a given module 22, while others join together tube segments in adjoining modules. Each segment 70, 72, . . . , comprises an inner tube 76, which contains the heat transfer fluid, and an outer tube 74, which surrounds the inner tube and thus defines an insulating space between the inner and outer tubes. This space is typically evacuated, but may alternatively contain a suitable transparent heat-insulating material. Inner tube 76 typically comprises a metal with a radiation-absorbing coating, while outer tube 74 comprises a transparent material, such as glass.

Joint 78 connects inner tubes 76 of tube segments 70 and 72, while terminating outer tubes 74, so that the insulating space of each of the heat transfer tube segments is separate from the insulating space of the adjoining heat transfer tube segment. This design simplifies the assembly of tubes 24 in the field and also results in joint 78 having a smaller outer diameter than outer tubes 74 of segments 70 and 72. Ring 49, shown at the upper end of a support arm 80, contains bearings 82, which have an inner diameter that is chosen to securely engage the outer diameter of joint 78, as shown in FIG. 5B. After joint 78 has been inserted through ring 49 and joined to inner tube 76 of the adjoining segment 72, bearings 82 are able to roll against the joint. Heat transfer tube 24 can thus remain stationary at the center line of the frame of module 22 while the frame rotates about the center.

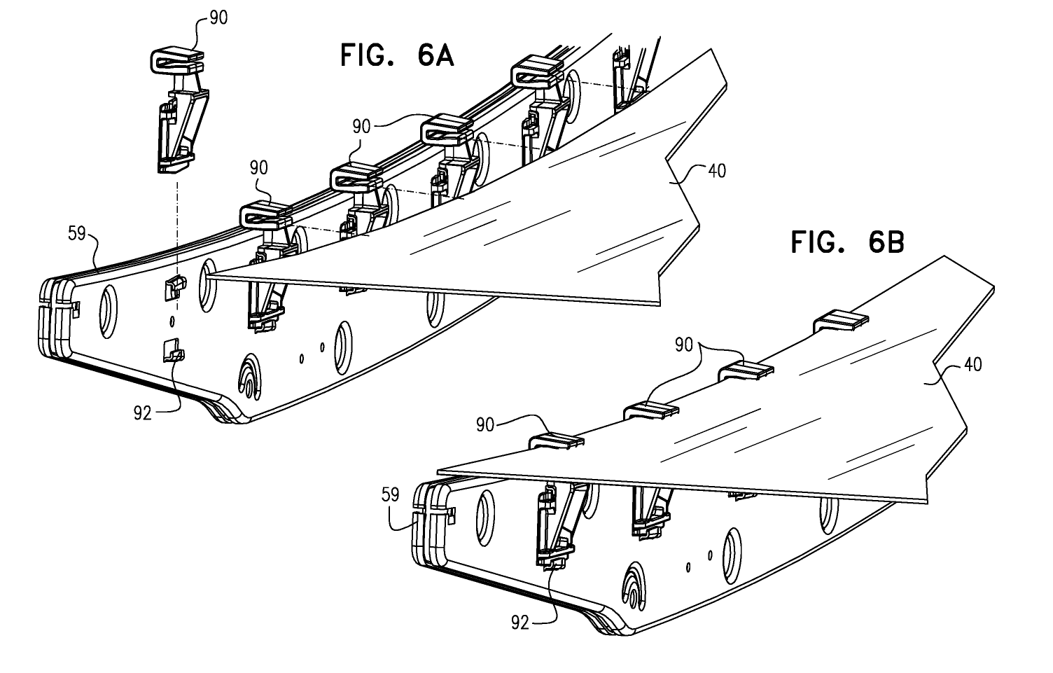

References is now made to FIGS. 6A and 6B, which are schematic pictorial illustrations showing assembly of mirror segment 40 onto support 59, in accordance with an embodiment of the present invention. FIG. 6A is an exploded view, illustrating the assembly process, while FIG. 6B shows the elements of FIG. 6A after assembly. As noted earlier, mirror segment 40 may comprise a sheet of tempered glass, typically on the order of 3 mm thick (although thinner or thicker sheets may alternatively be used), which bends to conform to the parabolic profile of support 59.

Mirror segment 40 is secured to supports 59 (or, on one side, to end segment 42) by clips 90, which may be molded from a suitable plastic or metal. The clips grip the margin of the tempered plate glass and are attached to support 59 in proximity to the parabolic inner edge so as to secure the mirror segments to the frame and hold the mirror in the desired parabolic shape. Clips 90 may clip into corresponding receptacles 92 distributed along the inner edge of support 92. This approach facilitates easy assembly while minimizing the risk of breaking the glass mirror segments.

### On-Site Assembly of the System

In an embodiment of the present invention, the parts of system 20 are pre-formed in a factory and are then assembled on site in the configuration shown in FIG. 1. The parts of system 20 are therefore designed for compactness, to simplify transport from the factory to the site, and for ease of assembly. Typically, the parts are stamped or roll-formed in the factory and are then pre-galvanized, to ensure durability in the harsh outdoor environment in which the system is installed. It is desirable that little or no welding be required in assembling the system on site, since welding calls for skilled labor, may give inconsistent results, and generally necessitates that galvanization or another sort of protective coating be applied after assembly. Instead, the pre-formed parts of system 20 are assembled without welding on site, generally using methods of clinching or riveting instead. This mode of installation also makes it possible to disassemble modules 22 after installation and reassemble them at another location.

A further challenge to be met in assembling system 20 is the need for accurate alignment of mirror segments 40, so that the sun's rays are focused tightly on heat transfer tubes 24. Generally speaking, the manufacturing tolerances of the factory-made parts of the system are too great when assembled to give the desired accuracy. To overcome this problem, special jigs and other means for alignment are provided to enable personnel to assemble the system on site to the desired accuracy. Some of these features are shown in the figures that follow.

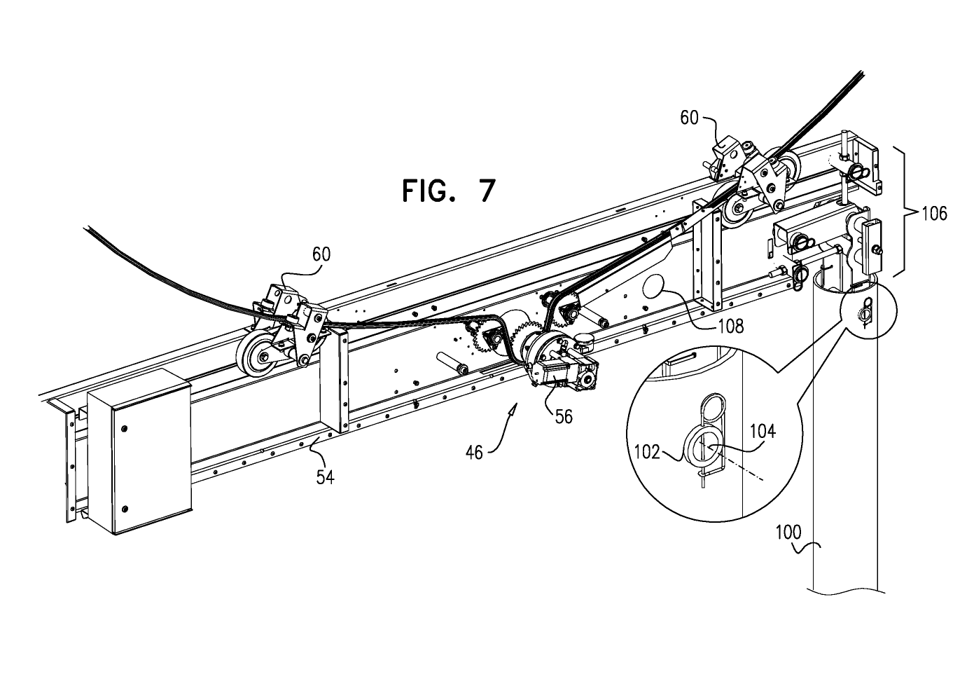

FIG. 7 is a schematic pictorial illustration showing assembly of base 54 of solar trough module 22, in accordance with an embodiment of the present invention. Each such base is mounted on a pair of foundation posts 100, which are driven into the ground before attachment of the base. To compensate for the large tolerances incurred in placement of posts 100 in the ground, the position and angle of each post is measured, and a hole 102 is drilled at a location selected to compensate for deviations from the target position and angle. Base 54 is mounted on posts 100 and secured in place by pins 104 inserted through hole 102 in each post.

The angle of base 54 is then adjusted using a three-axis positioning assembly 106 at each end of the base. The adjustment of assembly 106 is important not only to ensure that base 54 is properly leveled, but also to bring it into alignment with the other bases, spaced apart along the length of the solar trough. To aid in alignment, bases 54 have sight holes 108. During installation and adjustment, a laser beam, for example, may be directed through the sight holes of the entire row of bases, and assemblies 106 may then be adjusted to align all of the bases to within the desired tolerance.

After adjustment of assembly 106, locking bolts are tightened to prevent any further motion and hold base 54 in alignment. If necessary, however, the bolts may subsequently be loosened, and assemblies 106 may be readjusted to compensate for settling or other shifts that may occur over time.

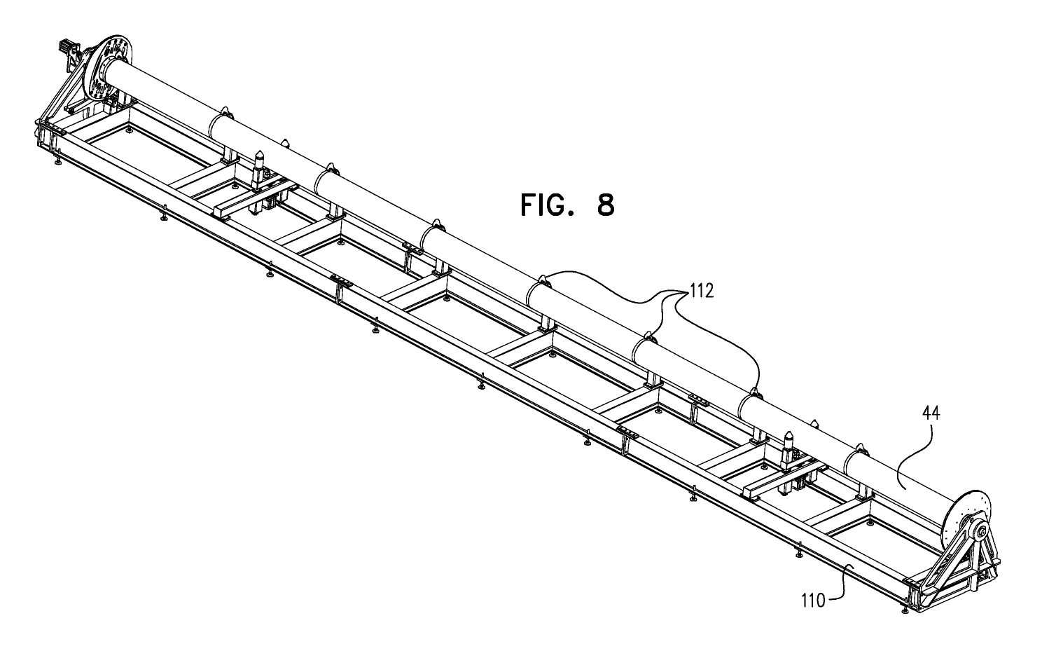

FIG. 8 is a schematic pictorial illustration showing assembly of clamps 112 on torque tube 44, using a jig 110, in accordance with an embodiment of the present invention. Clamps 112 have protruding tabs, as shown in the figure, to which the ends of mirror supports 59 are attached.

Torque tubes 44 are typically shipped to the installation site as bare tubes, separate from clamps 112, in order to facilitate compact packing and ease of transportation. On the other hand, it is important that the tabs for attachment of supports 59 be positioned precisely in order to ensure proper alignment of mirror segments 40. For this purpose, the bare torque tubes are mounted on jig 110, which guides the user to place clamps 112 in the proper locations, to within the required tolerance. After positioning the clamps, the user fastens them in place, and the torque tube is ready for use.

After installation of foundation posts 100 and alignment of bases 54 on the foundation posts, end segments 42 are mounted on the basis, and torque tubes 44 are connected between the end segments. Mirror supports 59 are attached to the torque tubes at clamps 112, and then mirror segments 40 are fitted to the mirror supports as shown above in FIG. 6A/B.

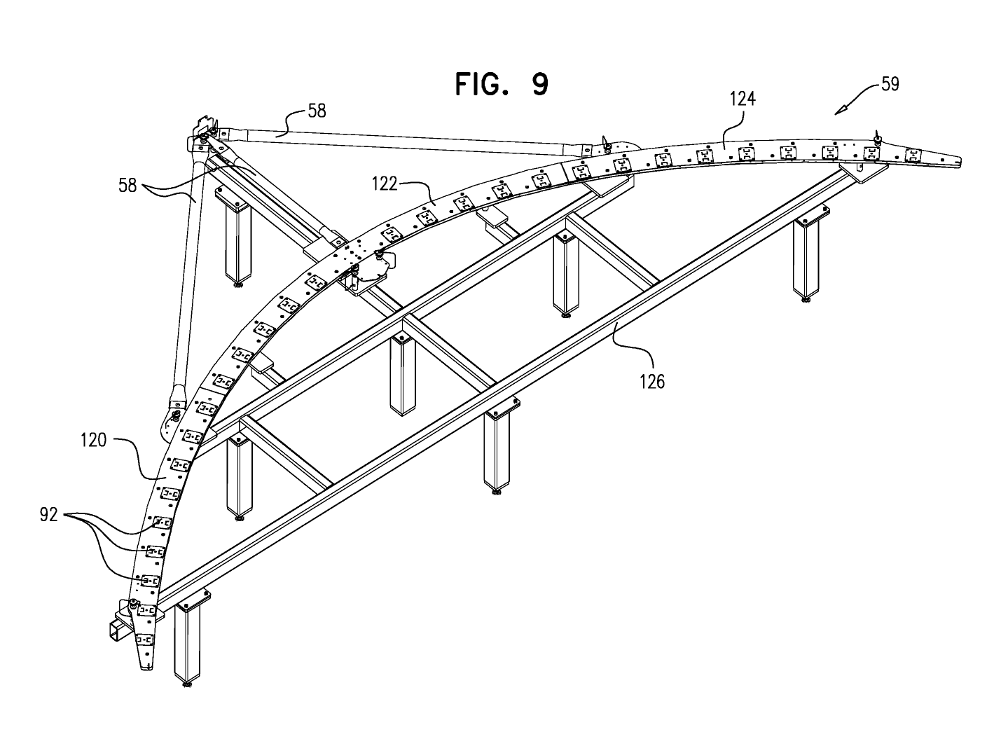

FIG. 9 is a schematic pictorial illustration showing assembly of mirror support 59, in accordance with an embodiment of the present invention. For ease of transport, the mirror support is made of three sections 120, 122, 124, which are assembled on site. Sections 120, 122, 124 may be formed by stamping but must be assembled precisely to ensure that mirror segments 40 have the proper shape and alignment. For this purpose, sections 120, 122 and 124 are placed in a jig 126, which ensures that they are properly aligned, together with struts 58, and the parts are then fastened together.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A solar thermal energy system, comprising:
a plurality of modules, which are configured to be connected end-to-end to define an extended solar trough, wherein each module comprises:
a frame, having an outer edge of circular profile and an inner edge of parabolic profile, having a focus at a geometrical center of the circular profile, the frame comprising first and second end segments at respective first and second ends of the module, and a pair of rigid torque tubes connected longitudinally between the first and second end segments;
a motorized drive, which is configured to engage and rotate the outer edge of the frame about the geometrical center;
multiple mirror segments fitted to the inner edge of the frame; and
at least one heat transfer tube segment, which is held stationary at the geometrical center of the frame while the frame rotates and is configured to be connected to the heat transfer tube segment of an adjoining module, whereby a heat transfer fluid flows between the connected segments.

2. The system according to claim 1, wherein the end segments comprise the outer edge that is engaged by the motorized drive, and wherein the frame comprises:
multiple mirror supports, which define the inner edge of parabolic profile; and
a truss structure below the parabolic profile, connecting the mirror supports to the end segments.

3. The system according to claim 2, wherein the mirror supports have respective first and second ends, and wherein each end is connected to one of the pair of torque tubes.

4. The system according to claim 2, wherein the end segments, mirror supports, and truss structure are pre-galvanized and are connected to one another on site without welding.

5. The system according to claim 1, wherein the second end segment serves as the first end segment of the adjoining module.

6. The system according to claim 1, wherein the motorized drive comprises a respective motor that is coupled to rotate each end segment.

7. The system according to claim 6, wherein the motorized drive comprises:
a chain, which is attached to and extends around the outer edge of the end segment; and
a drive wheel, which is coupled to engage the chain and is driven to rotate by the respective motor so as to advance along the chain, thereby rotating the frame.

8. The system according to claim 7, and comprising a pair of sensors, which are configured to sense advancement of the chain and to provide, responsively to the advancement, signals indicative of an angle of inclination of the frame.

9. The system according to claim 1, and comprising multiple bases, which are mounted on foundation posts and are configured to support the plurality of the modules, each of the bases comprising a positioning assembly, which is operable to align the bases with one another along the extended solar trough, thereby aligning the modules supported by the bases.

10. The system according to claim 1, wherein the mirror segments comprise tempered plate glass, which is bent to conform to the inner edge of the frame.

11. The system according to claim 10, wherein each module comprises multiple clips, which are configured to grip a margin of the tempered plate glass and to be attached to the frame in proximity to the inner edge so as to secure the mirror segments to the frame.

12. The system according to claim 1, wherein the at least one heat transfer tube segment comprises:
an inner tube, for containing the heat transfer fluid;
an outer tube, surrounding the inner tube and defining an insulating space between the inner and outer tubes; and
one or more joints for connecting the inner tube of the at least one heat transfer tube segment to the inner tube of an adjoining heat transfer tube segment, while terminating the outer tubes so that the insulating space of the heat transfer tube segment is separate from the insulating space of the adjoining heat transfer tube segment.

13. The system according to claim 12, wherein each module comprises at least one tube support, which comprises:
a base, which is fixed to the frame; and
a ring, which is configured to hold one of the joints of the heat transfer tube segment at the geometrical center of the circular profile, and which contains bearings configured to roll against the one of the joints so that the heat transfer tube segment remains stationary while the frame rotates about the center.

14. The system according to claim 1, wherein a center of mass of the frame is not located at the geometrical center of the circular profile.

15. Apparatus for capture of solar energy, comprising:
a solar trough, comprising a mirror having a parabolic profile, which is configured to focus solar energy toward a focus of the parabolic profile;
a motorized drive, which is coupled to rotate the mirror about the focus;
a heat transfer tube, comprising multiple tube segments, which are connected at joints therebetween so that a heat transfer fluid can flow between the connected segments; and
a plurality of tube supports, each comprising:
a base, which is fixed to the solar trough; and
a ring, which is configured to hold one of the joints of the heat transfer tube at the focus of the parabolic profile, and which contains bearings configured to roll against the one of the joints so that the heat transfer tube remains stationary while the frame rotates about the center.

16. The apparatus according to claim 15, wherein the heat transfer tube has a first outer diameter, and the joints have a second outer diameter, which is smaller than the first diameter, and wherein the bearings of the ring define an inner diameter that engages the second outer diameter.

17. The apparatus according to claim 15, wherein each of the tube segments comprises:
an inner tube, for containing the heat transfer fluid; and
an outer tube, surrounding the inner tube and defining an insulating space between the inner and outer tubes,
wherein the joints connect the inner tube of each of the tube segments to the inner tube of an adjoining tube segment, while terminating the outer tube so that the insulating space of each of the heat transfer tube segments is separate from the insulating space of the adjoining heat transfer tube segment.

18. A solar reflector, comprising:
a frame, having an inner edge of parabolic profile, which defines a focal line; and
multiple mirror segments, comprising tempered plate glass, which are fitted side-by-side to the inner edge of the frame while bending to conform to the parabolic profile.

19. The reflector according to claim 18, and comprising multiple clips, which are configured to grip a margin of the tempered plate glass and to be attached to the frame in proximity to the inner edge so as to secure the mirror segments to the frame.

20. The reflector according to claim 19, wherein the clips are configured to clip into corresponding receptacles distributed along the inner edge of the frame.

21. A method for assembling a solar thermal energy system, comprising:
providing a plurality of modules, each module comprising a frame, which has an outer edge of circular profile and an inner edge of parabolic profile, having a focus at a center of the circular profile, the frame comprising first and second end segments at respective first and second ends of the module, and a pair of rigid torque tubes connected longitudinally between the first and second end segments;
mounting one or more heat transfer tube segments in a stationary position at the center of the frame of each module;
fitting multiple mirror segments to the inner edge of the frame of each module;
connecting the plurality of the modules together, end-to-end, so as to define an extended solar trough;
applying a respective motorized drive to each module so as to engage and rotate the outer edge of the frame about the center; and
joining together the heat transfer tube segments of the connected modules, whereby a heat transfer fluid flows between the joined tube segments.

22. The method according to claim 21, wherein fitting the multiple mirror segments comprises bending sheets of tempered plate glass to conform to the inner edge of the frame.

23. The method according to claim 21, wherein each of the heat transfer tube segments comprises an inner tube, for containing the heat transfer fluid, and an outer tube, surrounding the inner tube and defining an insulating space between the inner and outer tubes, and
wherein joining together the heat transfer tube segments comprises connecting the inner tube of each heat transfer tube segment to the inner tube of an adjoining heat transfer tube segment, while terminating the outer tube so that the insulating space of each heat transfer tube segment is separate from the insulating space of the adjoining heat transfer tube segment.

24. The method according to claim 23, wherein connecting the inner tube comprises forming a joint, and wherein mounting the one or more heat transfer tube segments comprises fitting a ring of a tube support, having a base fixed to the frame, around the joint, wherein the ring contains bearings configured to roll against the joint so that the heat transfer tube segment remains stationary while the frame rotates about the center.

25. The method according to claim 21, and comprising mounting multiple bases on foundation posts, each of the bases comprising a positioning assembly, and adjusting the positioning assembly so as to align the bases with one another along the extended solar trough, wherein providing the plurality of the modules comprises mounting the frame of each module on a respective base.

26. The method according to claim 21, wherein providing the plurality of the modules comprises connecting mirror supports between the torque tubes, thereby defining the frame to support the multiple mirror segments.

27. The method according to claim 26, wherein assembling the torque tubes and connecting the mirror supports comprises fitting clamps to the torque tubes for connection of the mirror supports and assembling the mirror supports in a jig at a site of the thermal solar energy system without welding.

28. The method according to claim 26, wherein the end segments, mirror supports, and torque tubes are pre-galvanized and are connected to one another on site without welding.
